(19) United States
(12) Patent Application Publication
(10) Pub. No.: US 2016/0174268 A1
(43) Pub. Date: Jun. 16, 2016

(54) SMART HOME CONTROLLER AND COMMUNICATION METHOD THEREOF

(71) Applicant: HUIZHOU TCL MOBILE COMMUNICATION CO., LTD., HUIZHOU, GD (CN)

(72) Inventors: RONALD XUELONG HU, HUIZHOU (CN); AIPING GEORGE GUO, HUIZHOU (CN); SHIQING ZHAO, HUIZHOU (CN); XIN HU, HUIZHOU (CN); DAWANG XU, HUIZHOU (CN)

(21) Appl. No.: 14/899,927

(22) PCT Filed: Mar. 23, 2015
(86) PCT No.: PCT/CN2015/074864

§ 371 Date: Dec. 18, 2015

(30) Foreign Application Priority Data
Aug. 20, 2014 (CN) 201410413456

(51) Int. Cl. H04W 76/02; H04L 29/06; H04L 12/26; H04L 29/08; H04L 12/28

(52) U.S. Cl. CPC H04W 76/02; H04L 67/10; H04L 12/2803; H04L 43/14; H04L 69/02

(57) ABSTRACT

A communication method for a smart home controller which may include a smart home controller, which establishes a network connection with household appliances. The smart home controller receives a data packet sent by a household appliance. The smart home controller may determine the protocol type of the communication protocol supported by the household appliance through the protocol identifier. The smart home controller may select, based on the determination result, a protocol analysis program corresponding to the protocol type of the communication protocol from a plurality of protocol analysis programs, and may use the protocol analysis program to analyze the data packet, thereby achieving data transmission with the household appliance. At least one embodiment can realize data transmission between the smart home controller and a plurality of household appliances.

### TECHNICAL FIELD

The present disclosure relates to the field of communication technologies, and specifically to a communication method for a smart home controller and a smart home controller.

### BACKGROUND

Along with the development of Internet and wireless communications, the development of smart home systems has become increasingly great, wherein household appliances, that a smart home system involves, are smart products that people can have frequent contact with. Through local memory, local processing and local control, smart home controllers and household appliances form a smart family cloud (i.e. a cloud server), and the smart family cloud can be a relatively independent local network.

However, there is no industrial standard for smart family clouds regarding control communication protocols. Many manufacturers have developed their own communication protocols when producing their respective household appliances, such that the smart home controllers can only perform data transmission with household appliances of the same brand. For example, a smart home controller can only perform data transmission with refrigerators and washing machines of brand 1, and cannot perform data transmission with air conditioners of brand 2.

### SUMMARY

At least on embodiment provides a communication method for a smart home controller and a smart home controller that applies the method, which can realize data transmission between the smart home controller and a plurality of household appliances, and effectively improve the user experience.

At least one embodiment provides a communication method for a smart home controller, which includes a smart home controller which acquires at least one communication protocol supported by household appliances. The smart home controller can determine at least one protocol type of the communication protocols supported by household appliances. The smart home controller can save a protocol analysis program of the communication protocols corresponding to the at least one protocol type in a parallel way, such that the smart home controller can be compatible with a variety of communication protocols supported by a plurality of household appliances. The smart home controller can establish a network connection with household appliances. The smart home controller can receive a data packet sent by a household appliance, wherein the data packet includes a protocol identifier of the communication protocol supported by household appliance. The smart home controller can determine the protocol type of the communication protocol supported by the household appliance through the protocol identifier. The smart home controller can select, based on the determination result, a protocol analysis program corresponding to the protocol type of the communication protocol from a plurality of protocol analysis programs, and can use the protocol analysis program to analyze the data packet, thereby achieving data transmission with the household appliance. The smart home controller can routinely detect if the cloud server comprises a new communication protocol supported by the household appliance and if it does, the smart home controller can download and install a new version of the application that includes the new communication protocol, such that the smart home controller can be compatible with a variety of communication protocols supported by a plurality of household appliances.

At least one embodiment includes a data packet which further includes a protocol format of the communication protocol supported by household appliance and the data byte size of the data packet.

At least one embodiment includes a step where the smart home controller determines the protocol type of the communication protocol supported by the household appliance through the protocol identifier, where the the smart home controller searches the protocol identifier of the communication protocol supported by the household appliance from the data packet, where the smart home controller can analyze the protocol identifier of the communication protocol supported by the household appliance, and where the smart home controller can determine the protocol type of the communication protocol supported by the household appliance according to the analysis result.

At least one embodiment includes a step where the smart home controller can select, based on the determination result, a protocol analysis program corresponding to the protocol type of the communication protocol from a plurality of protocol analysis programs, and can use the protocol analysis program to analyze the data packet. The smart home controller can determine if it supports the protocol type of the communication protocol supported by the household appliance and if it does not, the smart home controller can acquire relevant information about the communication protocol supported by the household appliance. The relevant information about the communication protocol can include protocol format or a protocol identifier. The smart home controller can send the relevant information to a cloud server such that the cloud server acquires the communication protocol supported by the household appliance and forms a new version of the application. The smart home controller can download from the cloud server and install the new version of the application that includes the communication protocol supported by the household appliance. The smart home controller selects a protocol analysis program corresponding to the protocol type of the communication protocol from a plurality of protocol analysis programs of the new version of the application, and can use the protocol analysis program to analyze the data packet.

At least one embodiment provides a communication method for a smart home controller including where the smart home controller establishes a network connection with household appliances. The smart home controller can receive a data packet sent by a household appliance, wherein the data packet can include a protocol identifier of the communication protocol supported by household appliance. The smart home controller can determine the protocol type of the communication protocol supported by the household appliance through the protocol identifier. The smart home controller can select, based on the determination result, a protocol analysis program corresponding to the protocol type of the communication protocol from a plurality of protocol analysis programs, and can use the protocol analysis program to analyze the data packet, thereby achieving data transmission with the household appliance.

At least one embodiment provides a smart home controller that routinely detects if the cloud server comprises a new communication protocol supported by the household appliance and if it does, the smart home controller can download and install a new version of the application that comprises the new communication protocol, such that the smart home controller can be compatible with a variety of communication protocols supported by a plurality of household appliances.

At least one further embodiment includes the step that prior to when the smart home controller establishes a network connection with household appliances, the method further includes the smart home controller acquiring at least one communication protocol supported by household appliances. The smart home controller can determine at least one protocol type of the communication protocols supported by household appliances. The smart home controller saves a protocol analysis program of the communication protocols corresponding to the at least one protocol type in a parallel way, such that the smart home controller can be compatible with a variety of communication protocols supported by a plurality of household appliances.

In at least one further embodiment the step wherein the “smart home controller determines the protocol type of the communication protocol supported by the household appliance through the protocol identifier” includes where the smart home controller searches the protocol identifier of the communication protocol supported by the household appliance from the data packet. The smart home controller can analyze the protocol identifier of the communication protocol supported by the household appliance. The smart home controller can determine the protocol type of the communication protocol supported by the household appliance according to the analysis result.

In at least one further embodiment the step wherein the “smart home controller selects, based on the determination result, a protocol analysis program corresponding to the protocol type of the communication protocol from a plurality of protocol analysis programs, and uses the protocol analysis program to analyze the data packet” includes where the smart home controller determines if it supports the protocol type of the communication protocol supported by the household appliance, if it does not, the smart home controller can acquire relevant information about the communication protocol supported by the household appliance, wherein the relevant information about the communication protocol comprises protocol format or protocol identifier. The smart home controller can send the relevant information to a cloud server such that the cloud server acquires the communication protocol supported by the household appliance and forms a new version of the application. The smart home controller can download from the cloud server and install the new version of the application that comprises the communication protocol supported by the household appliance. The smart home controller can select a protocol analysis program corresponding to the protocol type of the communication protocol from a plurality of protocol analysis programs of the new version of the application, and can use the protocol analysis program to analyze the data packet.

At least one further embodiment provides a smart home controller, which can include a network connection module configured to establish a network connection with household appliances, a data receiving module connected with the network connection module and configured to receive a data packet sent by a household appliance, wherein the data packet comprises a protocol identifier of the communication protocol supported by household appliance, a protocol type determination module connected with the data receiving module and configured to determine the protocol type of the communication protocol supported by the household appliance through the protocol identifier, a data analysis module connected with the protocol type determination module and configured to select, based on the determination result, a protocol analysis program corresponding to the protocol type of the communication protocol from a plurality of protocol analysis programs, and use the protocol analysis program to analyze the data packet, thereby achieving data transmission with the household appliance.

At least one further embodiment of the smart home controller can include a protocol updating module, the protocol updating module being configured to routinely detect if the cloud server comprises a new communication protocol supported by the household appliance, and if it is detected that the cloud server comprises a new communication protocol supported by the household appliance, the data analysis module downloads and installs a new version of the application that comprises the new communication protocol, such that the smart home controller can be compatible with a variety of communication protocols supported by a plurality of household appliances.

At least one further embodiment of the smart home controller can include a protocol acquiring module, wherein the protocol acquiring module is configured to acquire at least one communication protocol supported by household appliances. The protocol type determination module can be connected with the protocol acquiring module, and configured to determine at least one protocol type of the communication protocols supported by household appliances. The data analysis module can be configured to save a protocol analysis program of the communication protocols corresponding to the at least one protocol type in a parallel way, such that the smart home controller can be compatible with a variety of communication protocols supported by a plurality of household appliances.

At least one further embodiment of the protocol type determination module can include a searching unit configured to search the protocol identifier of the communication protocol supported by the household appliance from the data packet, an analysis unit connected with the searching unit and configured to analyze the protocol identifier of the communication protocol supported by the household appliance, a protocol determination unit connected with the analysis unit and configured to determine the protocol type of the communication protocol supported by the household appliance according to the analysis result.

At least one further embodiment of the data analysis module can include a protocol support unit configured to determine if it supports the protocol type of the communication protocol supported by the household appliance, a protocol information acquiring unit connected with the protocol support unit and configured to acquire relevant information about the communication protocol supported by the household appliance if the protocol support unit determines that it does not support the protocol type of the communication protocol supported by the household appliance, wherein the relevant information about the communication protocol includes protocol format or protocol identifier, a sending unit connected with the protocol information acquiring unit and configured to send the relevant information to a cloud server such that the cloud server acquires the communication protocol supported by the household appliance and forms a new version of the application, a receiving unit configured to download from the cloud server and install the new version of the application that includes the communication protocol supported by the household appliance an analysis unit connected with the receiving unit and configured to select a protocol analysis program corresponding to the protocol type of the communication protocol from a plurality of protocol analysis programs of the new version of the application, and use the protocol analysis program to analyze the data packet.

Compared with the prior art, a communication method for a smart home controller is provided which establishes a network connection with household appliances through a smart home controller. The smart home controller can receive a data packet sent by a household appliance. The smart home controller can determine the protocol type of the communication protocol supported by the household appliance through the protocol identifier. The smart home controller can select, based on the determination result, a protocol analysis program corresponding to the protocol type of the communication protocol from a plurality of protocol analysis programs, and can use the protocol analysis program to analyze the data packet. By determining the protocol type of the communication protocol supported by a household appliance, selecting a protocol analysis program corresponding to the protocol type of the communication protocol based on the protocol type, and performing protocol analysis on a data packet of the household appliance, at least one embodiment can achieve data transmission between the smart home controller and household appliances, and effectively improve the user experience.

### BRIEF DESCRIPTION OF THE DRAWINGS

FIG. 1 depicts a flow chart of a first example of the communication method for a smart home controller according to an embodiment of the present invention;

FIG. 2 depicts a flow chart of substeps of the step S103 in FIG. 1;

FIG. 3 depicts a flow chart of substeps of the step S104 in FIG. 1;

FIG. 4 depicts a flow chart of a second example of the communication method for a smart home controller according to an embodiment of the present invention;

FIG. 5 illustrates a structure of the smart home controller according to an embodiment of the present invention;

FIG. 6 illustrates a structure of the protocol type determination module in FIGS. 5; and

FIG. 7 illustrates a structure of the data analysis module in FIG. 5.

### DETAILED DESCRIPTION

Several embodiments of the present invention will be described in detail below with reference to the accompanying drawings and examples.

FIG. 1 depicts a flow chart of a communication method for a smart home controller according to at least one embodiment of the present invention. The communication method may include the smart home controller establishing a network connection with household appliances (Step S101). The smart home controller may establish a network connection with a plurality of household appliances such that the smart home controller can achieve unified control and management. The household appliances may be either products from different manufacturers or products from the same manufacturer. A few non-limiting examples of household appliances are vacuum machines, refrigerators, washing machines, air conditioners or TVs. Furthermore, the household appliances may be replaced by smart homes, such as door access, telephones, smart curtains, smart sofas or smart beds.

The communication method can further include the smart home controller receiving a data packet sent by a household appliance (Step S102). The data packet can include a protocol identifier and a protocol format of the communication protocol supported by household appliance, data byte size of the data packet, etc.

The communication method can further include the smart home controller determining the protocol type of the communication protocol supported by the household appliance through the protocol identifier (Step S103). In at least one embodiment of the present invention, the smart home controller can determine the protocol type of the communication protocol supported by the household appliance through the protocol identifier. In at least one further embodiment, the protocol type of the communication protocol supported by the household appliance may also be determined through the protocol format or other keywords.

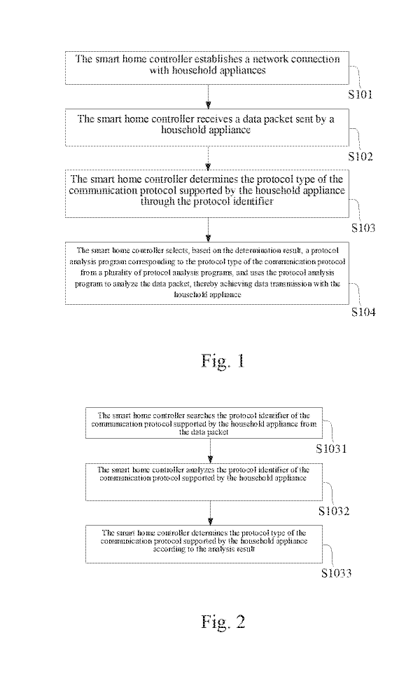

Turning to FIG. 2, a flow chart of substeps of the step S103 in FIG. 1, and the substeps of the step S103 may include the smart home controller searching the protocol identifier of the communication protocol supported by the household appliance from the data packet. Note that protocol identifiers are different for communication protocols supported by household appliances from different manufacturers. Therefore, the smart home controller would search the protocol identifier of the communication protocol supported by the household appliance from the data packet for each connection with the household appliance (Step S1031).

The substeps of the step S103 may include the smart home controller analyzing the protocol identifier of the communication protocol supported by the household appliance (Step S1032).

The substeps of the step S103 may include the smart home controller determining the protocol type of the communication protocol supported by the household appliance according to the analysis result. The smart home controller can identify the protocol type of the communication protocol supported by the household appliance according to the protocol identifier, and the smart home controller can further identify the type, manufacturer, model, serial number and ID number of the household appliance according to other information carried by the data packet (Step S1033).

The communication method can further include the smart home controller selecting, based on the determination result, a protocol analysis program corresponding to the protocol type of the communication protocol from a plurality of protocol analysis programs, and using the protocol analysis program to analyze the data packet (Step S104). Non limiting examples of the protocol type include UpnP or AllJoyn. For example, when it is determined that the protocol type of the communication protocol supported by the household appliance is UpnP, a protocol analysis program corresponding to UpnP is selected from a plurality of protocol analysis programs, and the protocol analysis program corresponding to UpnP is used to analyze the data packet. When it is determined that the protocol type of the communication protocol supported by the household appliance is AllJoyn, a protocol analysis program corresponding to AllJoyn is selected from a plurality of protocol analysis programs, and the protocol analysis program corresponding to AllJoyn is used to analyze the data packet. When the analysis is completed, moreover, it enters the application layer of the smart home controller, and performs data transmission on the application layer of the smart home controller, including data receiving, processing, control and storage. At the same time, the application layer of the smart home controller may be connected via Internet, thereby achieving data transmission with the household appliance.

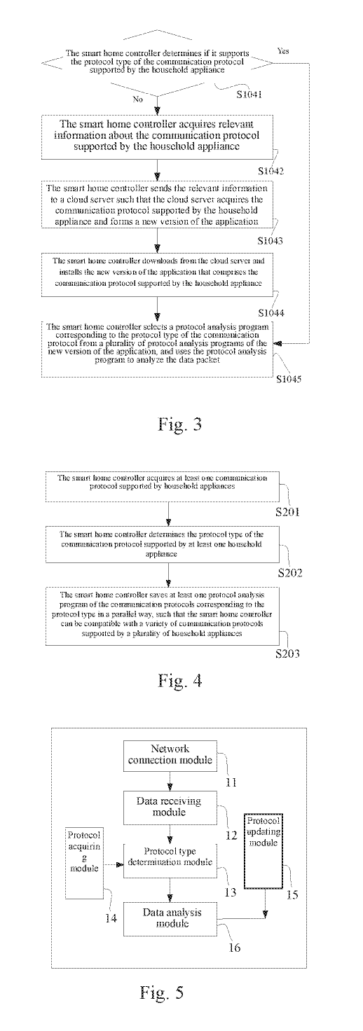

Turning to FIG. 3, a flow chart of substeps of the step S104 in FIG. 1, and the substeps of the step S104 may include the smart home controller determining if it supports the protocol type of the communication protocol supported by the household appliance (Step S1041). If the smart home controller determines that it does not support the protocol type of the communication protocol supported by the household appliance, it can indicate that the household appliance is a new household appliance, and go to Step S1042.

Step S1042 may include the smart home controller acquiring relevant information about the communication protocol supported by the household appliance, wherein the relevant information about the communication protocol can include the protocol format or the protocol identifier.

The substeps of the step S104 may include the smart home controller sending the relevant information to a cloud server such that the cloud server acquires the communication protocol supported by the household appliance and forms a new version of the application (Step S1043).

The substeps of the step S104 may include the smart home controller downloading from the cloud server and installing the new version of the application that comprises the communication protocol supported by the household appliance (Step S1044).

The substeps of the step S104 may include the smart home controller selecting a protocol analysis program corresponding to the protocol type of the communication protocol from a plurality of protocol analysis programs of the new version of the application, and using the protocol analysis program to analyze the data packet. Note that, after the smart home controller has downloaded and installed the new version of the application, the smart home controller has now saved the protocol analysis program of the communication protocol supported by the household appliance (Step S1045).

In at least one embodiment, if the smart home controller determines that it supports the protocol type of the communication protocol supported by the household appliance (S1041), the method can proceed to Step S1045. In at least one embodiment, after Step S1045, the smart home controller can label the new household appliance or household appliance of an unsupported protocol type, or memorize the protocol attributes of the new household appliance or household appliance of an unsupported protocol type. Thus, when the smart home controller performs data transmission with the new household appliance or household appliance of an unsupported protocol type next time, the smart home controller does not need to execute Step S1041 again. Instead, by directly determining the label of the new household appliance or household appliance of an unsupported protocol type, or determining the protocol attributes of the new household appliance or household appliance of an unsupported protocol type, the method can include directly selecting a protocol analysis program corresponding to the communication protocol from a plurality of protocol analysis programs to analyze the data packet from the new household appliance or household appliance of an unsupported protocol type, thereby saving the time for determining the protocol. Note that non-limiting examples of the protocol attributes may be the type, manufacturer, model, serial number and ID number of the new household appliance. For example, after Step S1045, the smart home controller can label the new household appliance with A1, and when the smart home controller performs data transmission with a new household appliance again, the smart home controller determines that the label of the new household appliance is A1. The smart home controller then directly selects a protocol analysis program corresponding to A1 from a plurality of protocol analysis programs to analyze the data packet from the new household appliance. Alternatively, the smart home controller determines the protocol attributes of the new household appliance, for example, when the smart home controller determines at least one of the type, manufacturer, model, serial number and ID number of the new household appliance, the smart home controller directly selects a protocol analysis program corresponding to the protocol attribute from a plurality of protocol analysis programs to analyze the data packet of the new household appliance. Thus, as long as any one or more of the protocol attributes for example type, manufacturer, model, serial number and ID number of the new household appliance is determined, a corresponding protocol analysis program can be selected to analyze the data packet of the new household appliance.

In at least one embodiment, the smart home controller can add protocol analysis programs of communication protocols corresponding to various protocol types in a building block way, for example prior to the Step S101, the smart home controller can save protocol analysis programs of communication protocols supported by a plurality of household appliances in a parallel way such that the smart home controller can be compatible with communication protocols supported by a plurality of household appliances.

FIG. 4 depicts a flow chart of a communication method for a smart home controller according to an embodiment of the present invention. The communication method may include the smart home controller acquiring at least one communication protocol supported by household appliances, wherein protocol analysis programs corresponding to communication protocols supported by a plurality of household appliances, such as UpnP or AllJoyn, may be acquired through downloading (Step S201).

The communication method can further include the smart home controller determining at least one protocol type of the communication protocols supported by household appliances (Step S202), wherein the Step S202 of the present example is the same as the Step S103 of the example above.

The communication method can further include the smart home controller saving a protocol analysis program of the communication protocols corresponding to the at least one protocol type in a parallel way, such that the smart home controller can be compatible with a variety of communication protocols supported by a plurality of household appliances (Step S203).

In at least one embodiment, after the smart home controller saves protocol analysis programs of communication protocols corresponding to a plurality of protocol types in a parallel way, the smart home controller routinely detects if the cloud server comprises a new communication protocol supported by the household appliance. If it detects that the cloud server does not comprise a new communication protocol supported by the household appliance, the smart home controller maintains the original version of the application. If the smart home controller detects that the cloud server comprises a new communication protocol supported by the household appliance, the smart home controller downloads and installs a new version of the application that comprises the new communication protocol, such that the smart home controller can be compatible with a variety of communication protocols supported by a plurality of household appliances or more communication protocols supported by household appliances to be developed in the future.

FIG. 5 illustrates the structure of the smart home controller according to an embodiment of the present invention, and the smart home controller in FIG. 5 is an example of the smart home controller referred to in FIG. 1. The smart home controller can include a network connection module 11, a data receiving module 12, a protocol type determination module 13, a protocol acquiring module 14, a protocol updating module 15 and a data analysis module 16. The network connection module 11 can be configured to establish a network connection with household appliances (not shown). The household appliances may be vacuum machines, refrigerators, washing machines, air conditioners or TVs. Furthermore, the household appliances may be replaced by smart homes, such as door access, telephones, smart curtains, smart sofas or smart beds.

The data receiving module 12 can be connected with the network connection module 11 and configured to receive a data packet sent by a household appliance, wherein the data packet can include a protocol identifier and a protocol format of the communication protocol supported by household appliance, data byte size of the data packet, etc. The protocol acquiring module 14 is configured to acquire at least one communication protocol supported by household appliances. The protocol type determination module 13 can be connected with the data receiving module 12 and the protocol acquiring module 14, respectively, and configured to, after acquiring the data packet received by the data receiving module 12 and acquiring the protocol identifier, determine the protocol type of the communication protocol supported by the household appliance through the protocol identifier, and configured to determine at least one protocol type of the communication protocols supported by the household appliances when the protocol acquiring module 14 acquires at least one communication protocol supported by household appliances.

In at least one embodiment of the present invention, the protocol type determination module 13 determines the protocol type of the communication protocol supported by the household appliance through the protocol identifier. In another embodiment of the present invention, the protocol type determination module 13 may also determine the protocol type of the communication protocol supported by the household appliance through the protocol format or other keywords.

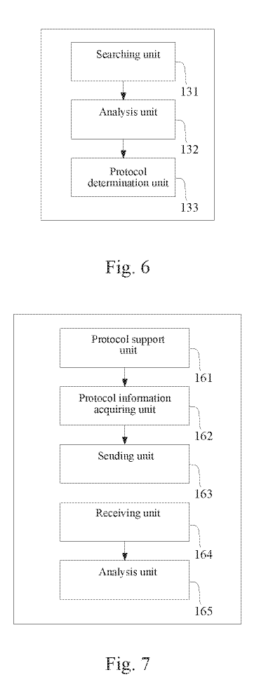

In at least one embodiment, depicted in FIG. 6, the protocol type determination module 13 can include a searching unit 131, an analysis unit 132 and a protocol determination unit 133. The searching unit 131 can be configured to search the protocol identifier of the communication protocol supported by the household appliance from the data packet. The analysis unit 132 is can be connected with the searching unit 131 and configured to analyze the protocol identifier of the communication protocol supported by the household appliance. The protocol determination unit 133 can be connected with the analysis unit 132 and configured to determine the protocol type of the communication protocol supported by the household appliance according to the analysis result. The protocol updating module 15 can be configured to routinely detect if the cloud server (not shown) includes a new communication protocol supported by the household appliance.

The data analysis module 16 can be connected with the protocol type determination module 13 and the protocol updating module 15, respectively. The data analysis module 16 can be configured to select, based on the determination result, a protocol analysis program corresponding to the protocol type of the communication protocol from a plurality of protocol analysis programs, and use the protocol analysis program to analyze the data packet, thereby achieving data transmission with the household appliance. The determination result is a result of the protocol type determination module 13 determining the protocol identifier of the data packet sent by the household appliance received by the data receiving module 12.

The data analysis module 16 can further be configured to, after the protocol type determination module 13 determines at least one protocol type of the communication protocols supported by the household appliances acquired by the protocol acquiring module 14, save a protocol analysis program of the communication protocols corresponding to the at least one protocol type in a parallel way, such that the smart home controller can be compatible with a variety of communication protocols supported by a plurality of household appliances. The data analysis module 16 can further be configured to, when the protocol updating module 15 detects that the cloud server comprises a new communication protocol supported by the household appliance, download and install a new version of the application that comprises the new communication protocol, such that the smart home controller can be compatible with a variety of communication protocols supported by a plurality of household appliances. The data analysis module 16 can further be configured to, when the protocol updating module 15 detects that the cloud server does not comprise a new communication protocol supported by the household appliance, maintain the original version of the application.

In at least one embodiment, depicted in FIG. 7, the data analysis module 16 can include a protocol support unit 161, a protocol information acquiring unit 162, a sending unit 163, a receiving unit 164 and an analysis unit 165. The protocol support unit 161 can be configured to determine if it supports the protocol type of the communication protocol supported by the household appliance. The protocol information acquiring unit 162 can be connected with the protocol support unit 161 and configured to acquire relevant information about the communication protocol supported by the household appliance if the protocol support unit 161 determines that it does not support the protocol type of the communication protocol supported by the household appliance, wherein the relevant information about the communication protocol includes the protocol format or the protocol identifier. The sending unit 163 can be connected with the protocol information acquiring unit 162 and configured to send the relevant information to a cloud server such that the cloud server acquires the communication protocol supported by the household appliance and forms a new version of the application. The receiving unit 164 can be configured to download from the cloud server and install the new version of the application that comprises the communication protocol supported by the household appliance. The analysis unit 165 can be connected with the receiving unit 164 and configured to select a protocol analysis program corresponding to the protocol type of the communication protocol from a plurality of protocol analysis programs of the new version of the application, and use the protocol analysis program to analyze the data packet.

In at least one embodiment the data analysis module 16 would label the new household appliance or household appliance of an unsupported protocol type, or memorize the protocol attributes of the new household appliance or household appliance of an unsupported protocol type. Thus, when the smart home controller performs data transmission with the new household appliance or household appliance of an unsupported protocol type next time, the smart home controller does not need to execute the determination of the communication protocol supported by the household appliance again. Instead, by directly determining the label of the new household appliance or household appliance of an unsupported protocol type, or determining the protocol attributes of the new household appliance or household appliance of an unsupported protocol type via the protocol type determination module 13, the data analysis module 16 can directly select a protocol analysis program corresponding to the communication protocol from a plurality of protocol analysis programs to analyze the data packet from the new household appliance or household appliance of an unsupported protocol type, thereby saving the time for determining the protocol.

Non-limiting examples of protocol attributes can include the type, manufacturer, model, serial number and ID number of the new household appliance. For example, the smart home controller labels the new household appliance with A1, and when the smart home controller performs data transmission with a new household appliance again, the protocol type determination module 13 determines that the label of the new household appliance is A1, then the data analysis module 16 directly selects a protocol analysis program corresponding to A1 from a plurality of protocol analysis programs to analyze the data packet from the new household appliance. In at least one further embodiment the protocol type determination module 13 determines the protocol attributes of the new household appliance, for example, when the protocol type determination module 13 determines at least one of the type, manufacturer, model, serial number and ID number of the new household appliance, the data analysis module 16 directly selects a protocol analysis program corresponding to the protocol attribute from a plurality of protocol analysis programs to analyze the data packet of the new household appliance. Namely, as long as any one or more of the type, manufacturer, model, serial number and ID number of the new household appliance is determined, a corresponding protocol analysis program can be selected to analyze the data packet of the new household appliance.

In at least one embodiment the communication method for a smart home controller according to an embodiment of the present invention establishes a network connection with household appliances through a smart home controller; the smart home controller receives a data packet sent by a household appliance; the smart home controller determines the protocol type of the communication protocol supported by the household appliance through the protocol identifier; the smart home controller selects, based on the determination result, a protocol analysis program corresponding to the protocol type of the communication protocol from a plurality of protocol analysis programs, and uses the protocol analysis program to analyze the data packet. At least one embodiment can achieve data transmission between the smart home controller and household appliances, and effectively improve the user experience determining the protocol type of the communication protocol supported by a household appliance, selecting a protocol analysis program corresponding to the protocol type of the communication protocol based on the protocol type, and performing protocol analysis on a data packet of the household appliance.

Non-limiting examples of embodiments of the present invention are described above, and the scope of the present invention is not limited thereby. Any equivalent structure or equivalent flow change based on the Specification and Drawings of the present invention, or direct or indirect applications in other related technical fields, shall all be encompassed by embodiments of the present invention. Therefore it should be understood that applications of the present invention are not limited to the above examples. To those skilled in the art, improvements or modifications may be made according to the above description, and all of these improvements or modifications shall be encompassed by the scope of the appended claims.

1. A communication method for a smart home controller, wherein the method comprises:
acquiring at least one communication protocol supported by household appliances;
determining at least one protocol type of the communication protocols supported by household appliances;
saving a protocol analysis program of the communication protocols corresponding to the at least one protocol type in a parallel way, where the smart home controller can be compatible with a variety of communication protocols supported by a plurality of household appliances;
establishing a network connection with household appliances;
receiving a data packet sent by the household appliance, wherein the data packet includes a protocol identifier of the communication protocol supported by household appliance;
determining the protocol type of the communication protocol supported by the household appliance through the protocol identifier;
selecting, based on the determination result, a protocol analysis program corresponding to the protocol type of the communication protocol from a plurality of protocol analysis programs, and uses the protocol analysis program to analyze the data packet, thereby achieving data transmission with the household appliance,
wherein, the smart home controller routinely detects if the cloud server includes a new communication protocol supported by the household appliance; if the household appliance does, the smart home controller downloads and installs a new version of the application that includes the new communication protocol, where the smart home controller can be compatible with a variety of communication protocols supported by a plurality of household appliances.

2. The communication method according to claim 1, wherein the data packet further includes a protocol format of the communication protocol supported by household appliance and the data byte size of the data packet.

3. The communication method according to claim 1, wherein the step of determining at least one protocol type of the communication protocols supported by household appliances comprises:
searching the protocol identifier of the communication protocol supported by the household appliance from the data packet;
analyzing the protocol identifier of the communication protocol supported by the household appliance; and
determining the protocol type of the communication protocol supported by the household appliance according to the analysis result.

4. The communication method according to claim 1, wherein the step of selecting, based on the determination result, a protocol analysis program
comprises:
determining if the smart home controller supports the protocol type of the communication protocol supported by the household appliance;
if the smart home controller does not, the smart home controller acquires relevant information about the communication protocol supported by the household appliance, wherein the relevant information about the communication protocol includes protocol format or protocol identifier;
sending the relevant information to a cloud server where the cloud server acquires the communication protocol supported by the household appliance and forms a new version of the application;
downloading from the cloud server and installing the new version of the application that includes the communication protocol supported by the household appliance;
selecting a protocol analysis program corresponding to the protocol type of the communication protocol from a plurality of protocol analysis programs of the new version of the application, and using the protocol analysis program to analyze the data packet.

5. A communication method for a smart home controller, wherein the method comprises:
establishing a network connection with household appliances;
receiving a data packet sent by the household appliance, wherein the data packet includes a protocol identifier of the communication protocol supported by household appliance;
determining the protocol type of the communication protocol supported by the household appliance through the protocol identifier; and
selecting, based on the determination result, a protocol analysis program corresponding to the protocol type of the communication protocol from a plurality of protocol analysis programs, and using the protocol analysis program to analyze the data packet, thereby achieving data transmission with the household appliance.

6. The communication method according to claim 5, wherein the method further comprises:
detecting if the cloud server includes a new communication protocol supported by the household appliance;
if the cloud server does, downloading and installing a new version of the application that includes the new communication protocol, where the smart home controller can be compatible with a variety of communication protocols supported by a plurality of household appliances.

7. The communication method according to claim 5, wherein the method further comprises:
acquiring at least one communication protocol supported by household appliances;
determining at least one protocol type of the communication protocols supported by household appliances; and
saving a protocol analysis program of the communication protocols corresponding to the at least one protocol type in a parallel way, where the smart home controller can be compatible with a variety of communication protocols supported by a plurality of household appliances.

8. The communication method according to claim 5, wherein the step of determining the protocol type of the communication protocol comprises:
searching the protocol identifier of the communication protocol supported by the household appliance from the data packet;
analyzing the protocol identifier of the communication protocol supported by the household appliance; and
determining the protocol type of the communication protocol supported by the household appliance according to the analysis result.

9. The communication method according to claim 5, wherein the step of selecting, based on the determination result, a protocol analysis program comprises:
determining if the smart home controller supports the protocol type of the communication protocol supported by the household appliance;
if the smart home controller does not, the smart home controller acquires relevant information about the communication protocol supported by the household appliance, wherein the relevant information about the communication protocol comprises protocol format or protocol identifier;
sending the relevant information to a cloud server where the cloud server acquires the communication protocol supported by the household appliance and forms a new version of the application;
downloading from the cloud server and installing the new version of the application that includes the communication protocol supported by the household appliance; and
selecting a protocol analysis program corresponding to the protocol type of the communication protocol from a plurality of protocol analysis programs of the new version of the application, and using the protocol analysis program to analyze the data packet.

10. A smart home controller, wherein the smart home controller comprises:
a network connection module configured to establish a network connection with household appliances;
a data receiving module connected with the network connection module and configured to receive a data packet sent by the household appliance, wherein the data packet includes a protocol identifier of the communication protocol supported by household appliance;
a protocol type determination module connected with the data receiving module and configured to determine a protocol type of the communication protocol supported by the household appliance through the protocol identifier; and
a data analysis module connected with the protocol type determination module and configured to select, based on the determination result, a protocol analysis program corresponding to the protocol type of the communication protocol from a plurality of protocol analysis programs, and use the protocol analysis program to analyze the data packet, thereby achieving data transmission with the household appliance.

11. The smart home controller according to claim 10, wherein the smart home controller further comprises:
a protocol updating module, the protocol updating module configured to routinely detect if the cloud server includes a new communication protocol supported by the household appliance, and if it is detected that the cloud server includes a new communication protocol supported by the household appliance, the data analysis module downloads and installs a new version of the application that includes the new communication protocol, such that the smart home controller can be compatible with a variety of communication protocols supported by a plurality of household appliances.

12. The smart home controller according to claim 10, wherein the smart home controller further comprises:
a protocol acquiring module, wherein the protocol acquiring module is configured to acquire at least one communication protocol supported by household appliances, wherein the protocol type determination module is connected with the protocol acquiring module, and configured to determine at least one protocol type of the communication protocols supported by household appliances, wherein the data analysis module is configured to save a protocol analysis program of the communication protocols corresponding to the at least one protocol type in a parallel way, where the smart home controller can be compatible with a variety of communication protocols supported by a plurality of household appliances.

13. The smart home controller according to claim 10, wherein the protocol type determination module comprises:
a searching unit configured to search the protocol identifier of the communication protocol supported by the household appliance from the data packet;
an analysis unit connected with the searching unit and configured to analyze the protocol identifier of the communication protocol supported by the household appliance; and
a protocol determination unit connected with the analysis unit and configured to determine the protocol type of the communication protocol supported by the household appliance according to the analysis result.

14. The smart home controller according to claim 10, wherein the data analysis module comprises:
a protocol support unit configured to determine if the protocol support unit supports the protocol type of the communication protocol supported by the household appliance;
a protocol information acquiring unit connected with the protocol support unit and configured to acquire relevant information about the communication protocol supported by the household appliance if the protocol support unit determines that the protocol support unit does not support the protocol type of the communication protocol supported by the household appliance, wherein the relevant information about the communication protocol includes protocol format or protocol identifier;
a sending unit connected with the protocol information acquiring unit and configured to send the relevant information to a cloud server where the cloud server acquires the communication protocol supported by the household appliance and forms a new version of the application;
a receiving unit configured to download from the cloud server and install the new version of the application that comprises the communication protocol supported by the household appliance; and
an analysis unit connected with the receiving unit and configured to select a protocol analysis program corresponding to the protocol type of the communication protocol from a plurality of protocol analysis programs of the new version of the application, and use the protocol analysis program to analyze the data packet.

15. The method according to claim 1 further including:
labeling a household appliance of an unsupported protocol type.

16. The method according to claim 1 further including:
storing protocol attributes of a new household appliance or a household appliance of an unsupported protocol type.

17. The method according to claim 16, where the protocol attributes include at least one of the type, manufacturer, model, serial number and ID number of the new household appliance.

18. The controller according to claim 10 where the data analysis module labels a household appliance of an unsupported protocol type.

19. The controller according to claim 10 where the data analysis module stores protocol attributes of a new household appliance or a household appliance of an unsupported protocol type.

20. The controller according to claim 19, where the protocol attributes include at least one of the type, manufacturer, model, serial number and ID number of the new household appliance.
